(19) United States
(12) Patent Application Publication
(10) Pub. No.: US 2026/0045653 A1
(43) Pub. Date: Feb. 12, 2026

(54) ELECTRODE TAB, BATTERY PACK, AND METHOD FOR MANUFACTURING ELECTRODE TAB

(71) Applicant: Samsung SDI Co., Ltd., Yongin-si (KR)

(72) Inventor: Sanghun Park, Yongin-si (KR)

(73) Assignee: Samsung SDI Co., Ltd., Yongin-si (KR)

(21) Appl. No.: 19/247,552

(22) Filed: Jun. 24, 2025

(30) Foreign Application Priority Data
Aug. 7, 2024 (KR) 10-2024-0105739

(51) Int. Cl. H01M 50/533; H01M 10/04; H01M 50/213; H01M 50/298; H01M 50/536

(52) U.S. Cl. CPC H01M 50/533; H01M 10/0431; H01M 50/213; H01M 50/298; H01M 50/536

(57) ABSTRACT

Disclosed are an electrode tab, a battery pack, and a method for manufacturing an electrode tab. The electrode tab is an electrode tab electrically connected to a terminal of a battery cell and may include: a bonding portion formed to have an area corresponding to an area of the terminal of the battery cell and bonded to the terminal of the battery cell; a protruding portion that protrudes from the bonding portion; and a wire connection portion formed in the protruding portion and or connecting, to the electrode tab, a wire that is electrically connected to the battery cell.

### CROSS-REFERENCE TO RELATED APPLICATIONS

This present application claims priority to and the benefit under 35 U.S.C. § 119(a)-(d) of Korean Patent Application No. 10-2024-0105739, filed on Aug. 7, 2024, in the Korean Intellectual Property Office, the entire disclosure of which is incorporated herein by reference.

### FIELD

Aspects of some embodiments of the present disclosure relate to an electrode tab, a battery pack, and a method for manufacturing an electrode tab, and to an electrode tab including a bonding portion formed to have an area corresponding to an area of a terminal of a battery cell and a protruding portion formed to protrude from the bonding portion, a battery pack, and a method for manufacturing an electrode tab.

### BACKGROUND

Unlike primary batteries that are not designed to be charged, secondary batteries are designed to be discharged and recharged. Low-capacity secondary batteries are used in small portable electronic devices, such as smart phones, feature phones, notebook computers, digital cameras, and camcorders, while large-capacity secondary batteries are widely used as power sources for driving motors, such as of hybrid vehicles or electric vehicles, and for power storage. The secondary battery includes an electrode assembly comprising a positive electrode and a negative electrode, a case that accommodates the electrode assembly, and a terminal part connected to the electrode assembly.

The above information disclosed in this Background section is for enhancement of understanding of the background of the present disclosure, and therefore, it may contain information that does not constitute related (or prior) art.

### SUMMARY

An object of the present disclosure is to provide an electrode tab including a bonding portion formed to have an area corresponding to an area of a terminal of a battery cell and a protruding portion formed to protrude from the bonding portion, a battery pack, and a method for manufacturing an electrode tab.

However, the technical problem to be solved by the present disclosure is not limited to the above problem, and other problems not mentioned herein, and aspects and features of the present disclosure that would address such problems, will be clearly understood by those skilled in the art from the description of the present disclosure below.

An electrode tab according to an embodiment of the present disclosure is an electrode tab electrically connected to a terminal of the battery cell and may include: a bonding portion formed to have an area corresponding to an area of the terminal of the battery cell and bonded to the terminal of the battery cell; a protruding portion formed to protrude from the bonding portion; and a wire connection portion formed in the protruding portion and for connecting, to the electrode tab, a wire that is electrically connected to the battery cell.

In an embodiment, the wire connection portion may include one or more holes formed in a part of the protruding portion.

In an embodiment, the wire connection portion may connect the wire by allowing the wire to pass through the one or more holes, such that the wire can be wound and soldered.

In an embodiment, the wire connection portion may include one or more grooves formed in a part of the protruding portion.

In an embodiment, the wire connection portion may connect the wire by seating the wire in the one or more grooves, such that the wire can be soldered.

In an embodiment, the bonding portion may be bonded to the terminal of the battery cell through laser welding or resistance welding.

In an embodiment, the electrode tab may be formed through a hemming process or a casting process.

A battery pack according to an embodiment of the present disclosure may include: a plurality of battery cells; a plurality of electrode tabs each being electrically connected to a respective terminal of a respective one of the plurality of battery cells; and a plurality of wires that electrically connect the plurality of electrode tabs, wherein each electrode tab of the plurality of electrode tabs may include: a bonding portion formed to have an area corresponding to an area of the terminal of the battery cell and bonded to the terminal of the battery cell; a protruding portion formed to protrude from the bonding portion; and a wire connection portion formed in the protruding portion and for connecting the wire to the electrode tab.

In an embodiment, the wire connection portion may include one or more holes formed in a part of the protruding portion.

In an embodiment, the wire connection portion may connect the wire by allowing the wire to pass through the one or more holes, such that the wire can be wound.

In an embodiment, the wire connection portion may include one or more grooves formed in a part of the protruding portion.

In an embodiment, the wire connection portion may connect the wire by seating the wire in the one or more grooves, such that the wire can be soldered.

In an embodiment, the bonding portion may be bonded to the terminal of the battery cell through laser welding or resistance welding.

In an embodiment, the electrode tab may be formed through a hemming process or a casting process.

A method for manufacturing an electrode tab according to an embodiment of the present disclosure is a method for manufacturing an electrode tab electrically connected to a terminal of a battery cell and may include: forming a bonding portion such that the bonding portion has an area corresponding to an area of the terminal of the battery cell and the electrode tab is configured for bonding to the terminal of the battery cell, and a protruding portion that protrudes from the bonding portion; and forming, in the protruding portion, a wire connection portion for connecting a wire electrically connected to the battery cell.

In an embodiment, the forming of the wire connection portion may include forming one or more holes in a part of the protruding portion.

In an embodiment, the forming of the wire connection portion may further include connecting the wire by passing the wire through the one or more holes, winding the wire, and soldering the wire.

In an embodiment, the forming of the wire connection portion may include forming one or more grooves in a part of the protruding portion.

In an embodiment, the forming of the wire connection portion may further include connecting the wire by seating the wire in the one or more grooves and soldering the wire.

In an embodiment, the forming of the bonding portion and the protruding portion that protrudes from the bonding portion may include forming the bonding portion and the protruding portion through a hemming process or a casting process.

According to an embodiment of the present disclosure, the electrode tab is connected to the terminal of the battery cell through the bonding portion formed to have an area corresponding to the area of the terminal of the battery cell, so that the efficiency of the effective area of a welding part of the battery cell and the electrode tab can be improved.

According to an embodiment of the present disclosure, the protruding portion is formed at the bonding portion and the wire is connected through the wire connection portion included in the protruding portion, so that complex design due to the limitation of an area can be avoided, thereby improving workability and manufacturing a battery pack having a compact structure.

### BRIEF DESCRIPTION OF THE DRAWINGS

The following drawings attached to the present specification illustrate embodiments of the present disclosure, and further describe aspects and features of the present disclosure together with the detailed description of the present disclosure. Thus, the present disclosure should not be construed as being limited to the drawings:

FIG. 1A is a top perspective view of a cylindrical secondary battery;

FIG. 1B is a cross-sectional view of the cylindrical secondary battery;

FIG. 2A is a plan view illustrating the top surface of a battery cell;

FIG. 2B is a plan view illustrating a state in which an electrode tab is attached to the top surface of the battery cell;

FIG. 2C is a side view illustrating a state in which the electrode tab is attached to the top surface of the battery cell;

FIG. 3 is a plan view illustrating a state in which a plurality of battery cells are connected through the electrode tabs;

FIG. 4A is a perspective view of an electrode tab according to an embodiment of the present disclosure;

FIG. 4B is a plan view illustrating a state in which the electrode tab according to an embodiment of the present disclosure is attached to the top surface of a battery cell;

FIG. 4C is a side view illustrating a state in which the electrode tab according to an embodiment. of the present disclosure is attached to the top surface of the battery cell;

FIG. 5A is a diagram illustrating an embodiment in which a bonding portion of the electrode tab according to an embodiment of the present disclosure is bonded to a terminal of the battery cell;

FIG. 5B is a diagram illustrating another embodiment in which the bonding portion of the electrode tab according to an embodiment of the present disclosure is bonded to the terminal of the battery cell;

FIG. 6A is a diagram illustrating an embodiment of a wire connection portion of the electrode tab according to an embodiment of the present disclosure;

FIG. 6B is a diagram illustrating another embodiment of the wire connection portion of the electrode tab according to an embodiment of the present disclosure;

FIG. 7A is an exploded view illustrating a state in which the electrode tab according to an embodiment of the present disclosure is coupled to the battery cell and an insulator;

FIG. 7B is a coupling view illustrating a state in which the electrode tab according to an embodiment of the present disclosure is coupled to the battery cell and the insulator;

FIG. 8 is a drawing illustrating a state in which a plurality of battery cells are connected through the electrode tabs according to an embodiment of the present disclosure; and

FIG. 9 is a flowchart illustrating a method for manufacturing the electrode tab according to an embodiment of the present disclosure.

### DETAILED DESCRIPTION

Exemplary embodiments of the present disclosure will be described below in detail with reference to the accompanying drawings. Prior to the description, it is noted that the terms or words used in this specification and claims should not be construed as being limited to common or dictionary meanings but instead should be understood to have meanings and concepts in agreement with the spirit of the present disclosure based on the principle that an inventor can define the concept of each term suitably in order to describe his/her own invention in the best way possible. Accordingly, since the embodiments described in this specification and the configurations illustrated in the drawings are only an example of the present disclosure and they do not cover all the technical ideas of the present disclosure, it should be understood that various changes and modifications may be made at the time of filing this application.

It will be further understood that the terms “comprises/includes” and/or “comprising/including” when used herein, specify the presence of stated features, integers, steps, operations, elements, components, and/or groups thereof, but do not preclude the presence or addition of one or more other features, integers, steps, operations, elements, components, and/or groups thereof.

In order to facilitate understanding of the present disclosure, the accompanying drawings are not drawn to scale and the dimensions of some components may be exaggerated. It should be noted that the same reference numerals are designated to the same components in different embodiments. Reference to two compared elements, features, etc. as being “the same” means that they are “substantially the same”. Therefore, the phrase “substantially the same” may include a deviation that is considered low in the art, for example, a deviation of 5% or less. The uniformity of any parameter in a given region may mean that it is uniform from an average perspective.

Although the terms such as “first” and/or “second” are used to describe various components, these components are not limited by these terms, of course. These terms are only used to distinguish one component from another component. Thus, unless specifically stated to the contrary, a first component may be termed a second component without departing from the teachings of exemplary embodiments.

Throughout the specification, unless otherwise stated, each element may be singular or plural.

Arrangement of any component “above (or below) ” or “on (or under) ” a component may mean that any component is disposed in contact with the upper (or lower) surface of the component, as well as that other components may be interposed between the element and any element disposed on (or under) the element.

It will be understood that, when a component is referred to as being “connected”, “coupled”, or “joined” to another component, not only can it be directly “connected”, “coupled”, or “joined” to the other element, but also can it be indirectly “connected”, “coupled”, or “joined” to the other element with other elements interposed therebetween.

As used herein, the term “and/or” includes any and all combinations of one or more of the associate listed items. The use of “may” when describing embodiments of the present disclosure relates to “one or more embodiments of the present disclosure”. Expressions such as “at least one” and “one or more” preceding a list of elements modify the entire list of elements and do not modify the individual elements in the list.

Throughout the specification, when “A and/or B” is stated, it means A, B, or A and B, unless otherwise stated. In addition, when “C to D” is stated, it means C or more and D or less, unless specifically stated to the contrary.

When the phrase such as “at least one of A, B, and C”, “at least one of A, B, or C”, “at least one selected from the group of A, B, and C”, or “at least one selected from among A, B, and C” is used to designate a list of elements A, B, and C, the phrase may refer to any and all suitable combinations.

The term “use” may be considered synonymous with the term “utilize”. As used herein, the terms “substantially,” “about,” and similar terms are used as terms of approximation rather than as terms of degree, and are intended to account for inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Accordingly, a first element, component, region, layer, or section discussed below may be termed a second element, component, region, layer, or section without departing from the teachings of exemplary embodiments.

For ease of explanation in describing the relationship of one element or feature to another element(s) or feature(s) as illustrated in the drawings, spatially relative terms such as “beneath”, “below” , “lower” , “above”, and “upper” may be used herein. It will be understood that spatially relative positions are intended to encompass different directions of the device in use or operation in addition to the direction depicted in the drawings. For example, if the device in the drawings is turned over, any element described as being “below” or “beneath” another element would then be oriented “above” or “over” another element. Therefore, the term “below”may encompass both upward and downward directions.

The terminology used herein is for the purpose of describing embodiments of the present disclosure and is not intended to limit the present disclosure.

Examples of secondary batteries include a coin type, a cylindrical type, a prismatic type, and a pouch type. The present disclosure is applicable to a prismatic secondary battery. Therefore, the cylindrical secondary battery will first be briefly described prior to description of embodiments of the present disclosure.

In the case of a battery pack configured using a secondary battery, in order to stably supply power to a main system of a device connected to each battery cell, connection between a plurality of battery cells and a protection circuit module is needed, and the most commonly used method for connecting the plurality of battery cells and the protection circuit module is soldering. In such a case, the battery pack has a structure in which in order to connect the plurality of battery cells, electrode tabs are soldered to the battery cells and the electrode tabs soldered to the respective battery cells are connected, resulting in a complicated design due to the limitation of an area.

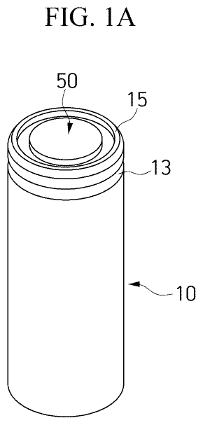

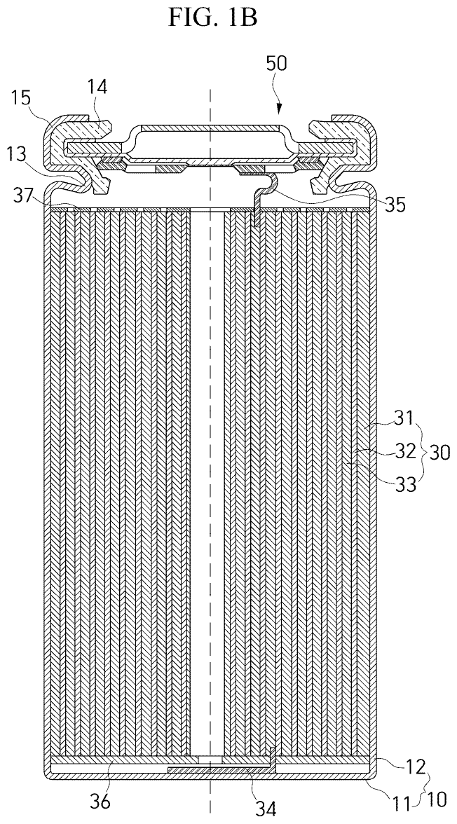

FIG. 1A is an upper perspective view of a cylindrical secondary battery. FIG. 1B is a cross-sectional view the cylindrical secondary battery.

Referring to FIGS. 1A and 1B, the cylindrical secondary battery may include an electrode assembly 30, a case 10 that accommodates the electrode assembly 30 and an electrolyte therein, a cap assembly 50 that is connected to an opening of the case 10 and that seals the case 10, and an insulating plate 37 disposed between the electrode assembly 30 and the cap assembly 50 within the case 10.

The electrode assembly 30 may include a separator 32, a first electrode 33, and a second electrode 31 with the separator 32 interposed between the first electrode 33 and the second electrode 31, and may be wound in a jelly-roll form.

The first electrode 33 may include a first base and a first active material layer disposed in the first base. A first lead tab 35 may extend from a first uncoated part that belongs to the first base and in which the first active material layer is not disposed, to the outside. The first lead tab 35 may be electrically connected to the cap assembly 50.

The second electrode 31 may include a second base and a second active material layer disposed in the second base. A second lead tab 34 may extend from a second uncoated part that belongs to the second base and in which the second active material layer is not disposed, to the outside. The second lead tab 34 may be electrically connected to the case 10. The first lead tab 35 and the second lead tab 34 may extend in opposite directions.

The first electrode 33 may function as a positive electrode. In this case, the first base may be composed of aluminum foil, for example. The first active material layer may include transition metal oxide, for example. The second electrode 31 may function as a negative electrode. In this case, the second base may be composed of copper foil or nickel foil, for example. The second active material layer may include graphite, for example.

The separator 32 functions to permit movement of lithium ions and to prevent the short-circuit of the first electrode 33 and the second electrode 31. The separator 32 may be composed of a polyethylene film, a polypropylene film, or a polyethylene-polypropylene film, for example. The case 10 may accommodate the electrode assembly 30 and an electrolyte, and forms an external form of the battery along with the cap assembly 50. The case 10 may include a body part 12 having an approximately cylindrical shape and a bottom part 11 connected to one side of the body part 12. A beading part 13 that has been deformed toward the inside of the body part 12 may be disposed in the body part 12. A crimping part 15 that has been bent toward the inside of the body part 12 may be disposed at an end of the body part 12 on the opening side.

The beading part 13 may suppress a movement of the electrode assembly 30 within the case 10, and may facilitate the settling of a gasket 14 and the cap assembly 50. The crimping part 15 may firmly fix the cap assembly 50 by pressurizing an edge of the cap assembly 50 through the gasket 14. The case 10 may be made of iron plated with nickel, for example. The cap assembly 50 may seal the case 10 by being fixed to the inside of the crimping part 15 through the gasket 14. The cap assembly 50 may include a cap-up part, a safety vent, a cap-down part, an insulating member, and a sub-plate, but the present disclosure is not limited to such examples. The cap assembly 50 may be variously deformed.

The cap-up part may be disposed at the top of the cap assembly 50. The cap-up part may include a terminal part that convexly protrudes upward and that is connected to an external circuit. An output for discharging a gas around the terminal part may be disposed in the cap-up part.

The safety vent may be disposed under the cap-up part. The safety vent may include a protruding part that convexly protrudes downward and that is connected to the sub-plate, and at least one notch disposed around the protruding part. When a gas is generated due to over-charging or an abnormal operation of the secondary battery, the protruding part may be deformed upward by the pressure of the gas and separated from the sub-plate. Furthermore, the safety vent may be cut along the notch. The cut safety vent can prevent the explosion of the secondary battery by discharging the gas to the outside.

The cap-down part may be disposed under the safety vent. A first opening for exposing the protruding part of the safety vent and a second opening for discharging a gas may be disposed in the cap-down part. The insulating member may be disposed between the safety vent and the cap-down part, and may insulate the safety vent and the cap-down part.

The sub-plate may be disposed under the cap-down part. The sub-plate may be fixed to the bottom of the cap-down part in order to close the first opening of the cap-down part. The protruding part of the safety vent may be fixed to the sub-plate. The first lead tab 35 that has been withdrawn from the electrode assembly 30 may be fixed to the sub-plate. Accordingly, the cap-up part, the safety vent, the cap-down part, and the sub-plate may be electrically connected to the first electrode 33 of the electrode assembly 30.

The insulating plate 37 may be disposed to adjoin the electrode assembly 30 under the beading part 13. A tab opening for withdrawing the first lead tab 35 may be provided in the insulating plate 37. The cap assembly 50 that has been electrically connected to the first electrode 33 by the first lead tab 35 may face the electrode assembly 30 with the insulating plate 37 interposed therebetween. The cap assembly 50 may maintain the state in which the cap assembly 50 has been insulated from the electrode assembly 30 by the insulating plate 37. The cylindrical secondary battery may include another insulating plate 36 for insulation between the electrode assembly 30 and the bottom part 11 of the case 10.

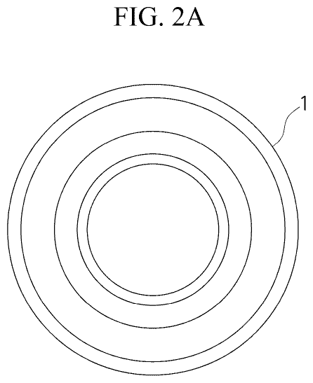

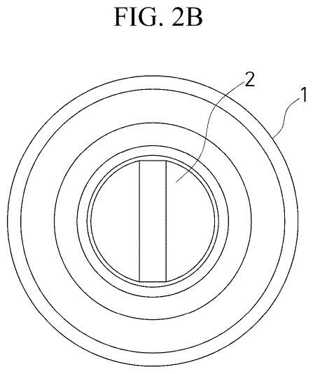

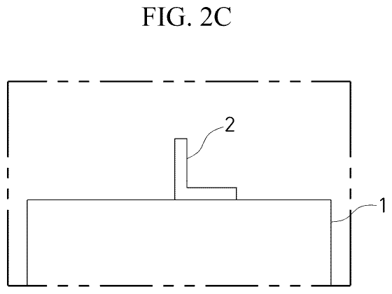

FIG. 2A is a plan view illustrating the top surface of a battery cell, FIG. 2B is a plan view illustrating a state in which an electrode tab in the related art is attached to the top surface of the battery cell, and FIG. 2C is a side view illustrating a state in which the electrode tab in the related art is attached to the top surface of the battery cell.

FIGS. 2A to 2C illustrate a state in which an electrode tab 2 in the related art is attached to a battery cell 1. The electrode tab 2 in the related art is made of a plate and is formed by bending once as illustrated in the drawings. Accordingly, the entire terminal region of the battery cell 1 is formed as a weldable region, but actually, a welding part of the battery cell 1 and the electrode tab 2 is formed only in a part of a terminal of the battery cell 1. Thus, since the bonding strength of the welding part of the battery cell 1 and the electrode tab 2 is weak after welding and the effective area of the welding part of the battery cell 1 and the electrode tab 2 is inefficient, there is a problem in that the flow of current in the battery cell 1 is not completely transmitted to the main system of a connected device.

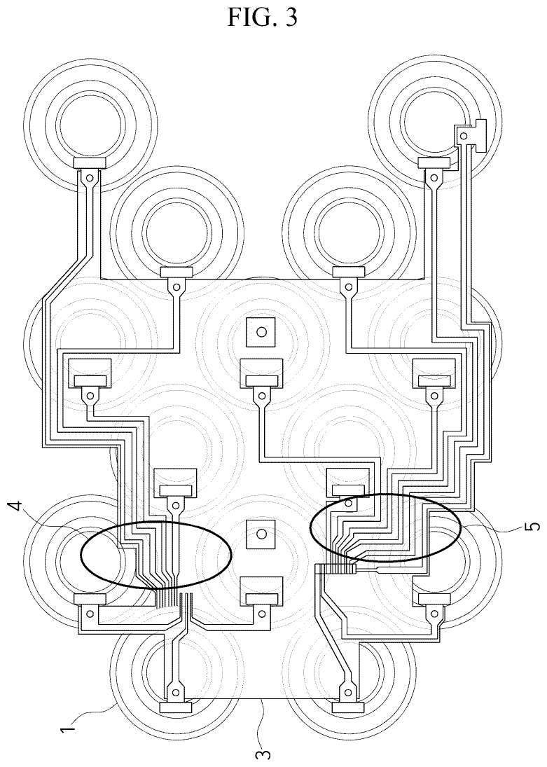

FIG. 3 is a plan view illustrating a state in which a plurality of battery cells are connected through the electrode tab in the related art.

Referring to FIG. 3, when connecting a plurality of battery cells 1 through the electrode tabs 2 in the related art, a coverlay 3 with an insulator added to the upper and lower surfaces of a conductor is used. However, in such a case, since a configurable area is limited, there is a problem in that the design is complicated in the case of areas where wires are concentrated, such as areas 4 and 5 indicated by ovals in FIG. 3.

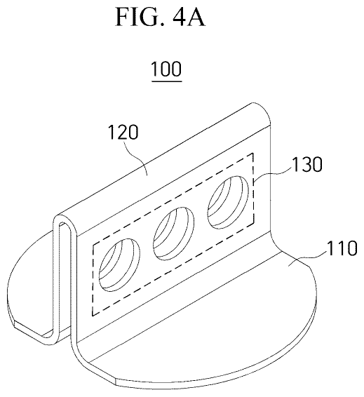

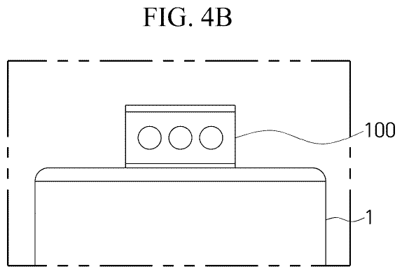

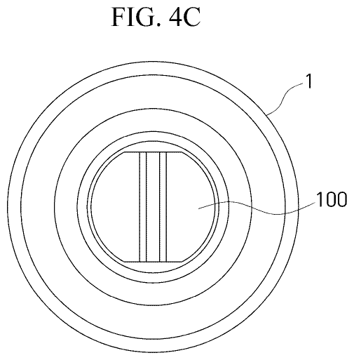

FIG. 4A is a perspective view of an electrode tab according to an embodiment of the present disclosure, FIG. 4B is a plan view illustrating a state in which the electrode tab according to an embodiment of the present disclosure is attached to the top surface of a battery cell, and FIG. 4C is a side view illustrating a state in which the electrode tab according to an embodiment of the present disclosure is attached to the top surface of the battery cell.

Referring to FIGS. 4A to 4C, an electrode tab 100 according to an embodiment of the present disclosure may include a bonding portion 110, a protruding portion 120, and a wire connection portion 130.

The electrode tab 100 according to an embodiment of the present disclosure is electrically connected to a terminal of a battery cell 1. In an embodiment, the electrode tab 100 is configured as an electrical connection member for electrically connecting a plurality of battery cells 1. The electrode tab 100 is electrically connected to the plurality of battery cells 1 in order to connect the plurality of battery cells 1 in series or in parallel. In an embodiment, the electrode tab 100 may be electrically connected to a terminal of at least one of the plurality of battery cells 1 by soldering. The material of the electrode tab 100 may be a metal material having good conductivity, and the electrode tab 100 may be made of at least one material selected from, for example, nickel, aluminum, copper, and silver. However, the electrode tab 100 of the present disclosure is not limited to the above material, and may include various materials as conductive materials.

The bonding portion 110 is bonded to the terminal of the battery cell 1. In an embodiment, the bonding portion 110 may be formed to have an area corresponding to the area of the terminal of the battery cell 1. In this way, the bonding portion 110 is formed to have an area corresponding to the area of the terminal of the battery cell 1, thereby securing an effective area of a welding part, reinforcing the bonding strength of the welding part, and allowing the flow of current in the battery cell 1 to be completely transmitted to the main system of a connected device. In an embodiment, the bonding portion 110 may be formed to have a shape corresponding to the shape of the terminal of the battery cell 1. For example, when the battery cell 1 is a cylindrical secondary battery as illustrated in FIGS. 4B and 4C, since the terminal of the battery cell 1 has a circular shape, the bonding portion 110 may also be formed to have a circular shape.

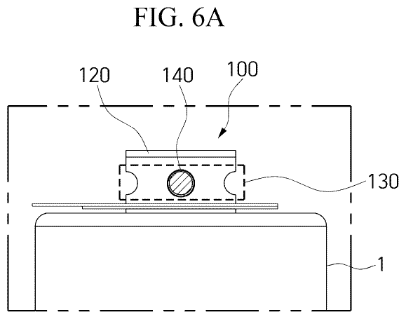

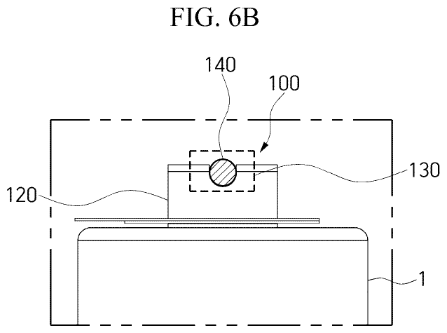

In an embodiment, the bonding portion 110 may be bonded to the terminal of the battery cell 1 through laser welding or resistance welding. FIGS. 6A and 6B below illustrate examples in which the bonding portion 110 of the electrode tab 100 according to an embodiment of the present disclosure is bonded to the terminal of the battery cell 1.

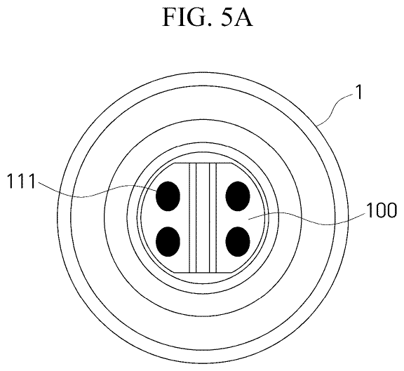

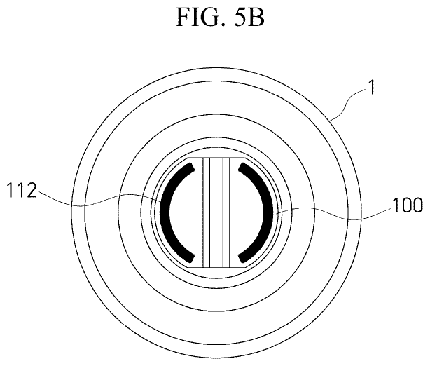

FIG. 5A is a diagram illustrating an embodiment in which the bonding portion of the electrode tab according to an embodiment of the present disclosure is bonded to the terminal of the battery cell.

Referring to FIG. 5A, the bonding portion 110 of the electrode tab 100 according to an embodiment of the present disclosure may be formed by resistance welding to the terminal of the battery cell 1 so that a plurality of resistance welding nuggets 111 are formed in a partial region of the bonding portion 110. According to the embodiment of FIG. 5A, the plurality of resistance welding nuggets 111 are formed, So that the bonding portion 110 may be firmly connected to the terminal of the battery cell 1.

FIG. 5B is a diagram illustrating another embodiment in which the bonding portion of the electrode tab according to an embodiment of the present disclosure is bonded to the terminal of the battery cell.

Referring to FIG. 5B, the bonding portion 110 of the electrode tab 100 according to an embodiment of the present disclosure may be formed by laser welding to the terminal of the battery cell 1 so that a plurality of welding lines 112 are formed in a partial region of the bonding portion 110.

In an embodiment, the welding lines 112 may be formed along the edge of the bonding portion 110. According to the embodiment of FIG. 5B, the plurality of welding lines 112 are formed, so that the bonding portion 110 may be firmly connected to the terminal of the battery cell 1.

Referring back to FIGS. 4A to 4C, the protruding portion 120 may be formed to protrude from the bonding portion 110. As illustrated in FIGS. 4A to 4C, the protruding portion 120 may have a U-shape, but this is according to an embodiment. That is, in other embodiments, the protruding portion 120 may have an I-shape or other shapes as needed.

In an embodiment, the electrode tab 100 may be formed through a hemming process or a casting process, and through this process, the bonding portion 110 and the protruding portion 120 may be formed. When the hemming process is performed, since the electrode tab 110 is formed through a process of folding a plate a plurality of times, the protruding portion 120 has a U-shape. When the casting process is performed, since the electrode tab 100 is formed through a process of melting metal, pouring the melted metal into a mold, and hardening the metal, the protruding portion 120 may have various shapes such as an I-shape as well as a U-shape.

The wire connection portion 130 is formed in the protruding portion 120 and connects a wire that is electrically connected to the battery cell 1. The wire connection portion 130 may be formed as one or more holes formed in the protruding portion 120 as illustrated in FIGS. 4A to 4C. In such a case, the wire connection portion 130 may connect the wire by allowing the wire to pass through the one or more holes, winding the wire, and then soldering the wire. In addition, the wire connection portion 130 may have other forms. Hereinafter, with reference to FIGS. 6A and 6B, various examples of the wire connection portion 130 of the electrode tab 100 according to an embodiment of the present disclosure are described.

FIG. 6A is a diagram illustrating an embodiment of a wire connection portion of the electrode tab according to an embodiment of the present disclosure.

Referring to FIG. 6A, in addition to one or more holes formed in a part of the protruding portion 120, the wire connection portion 130 may include one or more grooves formed in a part of the protruding portion 120. In FIG. 6A, it may be confirmed that the wire connection portion 130 includes a hole formed in the center of the protruding portion 120 and a groove formed on the side of the protruding portion 120. In the case of FIG. 6A, similarly to FIG. 4A, the wire connection portion 130 may connect a wire 140 by allowing the wire 140 to pass through the center hole, seating the wire 140 in the groove on the side, winding the wire 140, and then soldering the wire 140.

FIG. 6B is a diagram illustrating another embodiment of the wire connection portion of the electrode tab according to an embodiment of the present disclosure.

Referring to FIG. 6B, the wire connection portion 130 may include one groove formed in a part of the protruding portion 120. In FIG. 6B, it may be confirmed that the wire connection portion 130 has a groove formed in the center of the protruding portion 120. In the case of FIG. 6B, the wire connection portion 130 may connect the wire 140 by seating the wire 140 in the center groove and soldering the wire 140. According to an embodiment of the present disclosure, the electrode tab 100 is connected to the terminal of the battery cell 1 through the bonding portion 110 formed to have an area corresponding to the area of the terminal of the battery cell 1, so that the efficiency of the effective area of a welding part of the battery cell 1 and the electrode tab 100 can be improved.

According to an embodiment of the present disclosure, the protruding portion 120 is formed at the bonding portion 110 and the wire 140 is connected through the wire connection portion 130 included in the protruding portion 120, so that complex design due to the limited available area can be avoided, thereby improving workability and manufacturing a battery pack having a compact structure.

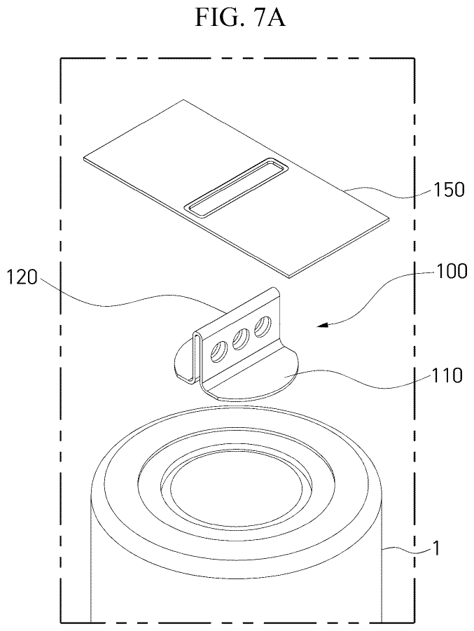

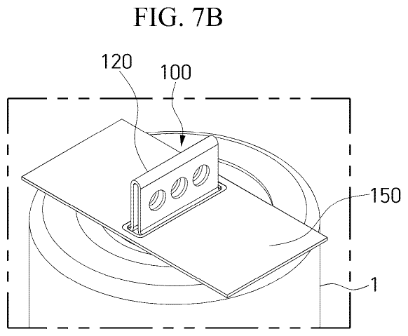

Hereinafter, with reference to FIGS. 7A and 7B, examples of configuring a battery pack by using the electrode tab 100 according to an embodiment of the present disclosure are described.

FIG. 7A is an exploded view illustrating a state in which the electrode tab according to an embodiment of the present disclosure is coupled to the battery cell and an insulator, and FIG. 7B is a coupling view illustrating a state in which the electrode tab according to an embodiment of the present disclosure is coupled to the battery cell and the insulator. Referring to FIGS. 7A and 7B, the electrode tab 100 according to an embodiment of the present disclosure may be coupled to the battery cell 1 and an insulator 150 before b being connected to a wire. The insulator 150 is used to prevent a short circuit caused by electrical connection with another undesired battery cell 1 when connecting the plurality of battery cells 1. In an embodiment, the insulator 150 may be formed with a communication hole corresponding to the shape of the protruding portion 120 of the electrode tab 100.

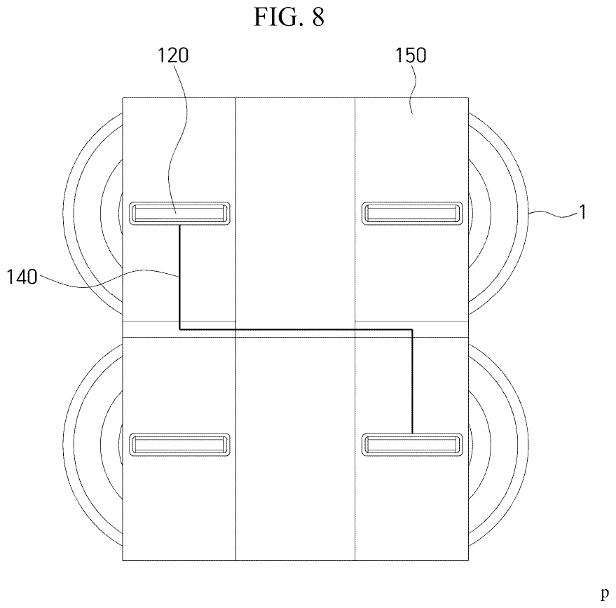

As illustrated in FIGS. 7A and 7B, the electrode tab 100 is attached to the terminal of the battery cell 1, and is covered by the insulator 150 except for the protruding portion 120 exposed through the communication hole of the insulator 150. Subsequently, in the electrode tabs 100 of the plurality of battery cells 1, the protruding portions 120 may be connected to each other by wires. Hereinafter, with reference to FIG. 8, an example in which the plurality of battery cells 1 are electrically connected through the electrode tabs 100 according to an embodiment of the present disclosure is described.

FIG. 8 is a drawing illustrating a state in which the plurality of battery cells are connected through the electrode tabs according to an embodiment of the present disclosure.

Referring to FIG. 8, when the electrode tab 100 is connected to the battery cell 1 and the insulator 150, only the protruding portions 120 of the plurality of battery cells 1 are exposed. In such a case, the wire 140 may be connected through the wire connection portion 130 formed on the protruding portion 120. In this way, in the electrode tab 100 according to an embodiment of the present disclosure, only the protruding portion 120 having the wire connection portion 130 is exposed, so that the wire connection portions 130 of the protruding portions 120 requiring electrical connection are connected to each other by the wire 140, thereby enabling simple electrical connection between the battery cells 1 without being restricted by the limited available area.

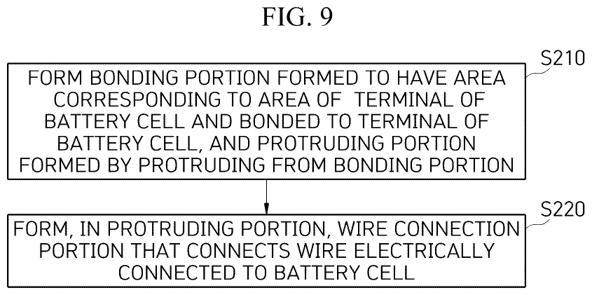

FIG. 9 is a flowchart illustrating a method for manufacturing the electrode tab according to an embodiment of the present disclosure.

As illustrated in FIG. 9, the method for manufacturing an electrode tab according to an embodiment of the present disclosure may include steps S210 and S220.

Step S210 is a step of forming a bonding portion formed to have an area corresponding to the area of a terminal of a battery cell and bonded to the terminal of the battery cell, and a protruding portion formed by protruding from the bonding portion. In an embodiment, step S210 may include a step of forming the bonding portion and the protruding portion through a hemming process or a casting process.

Step S220 is a step of forming, in the protruding portion, a wire connection portion that connects a wire electrically connected to the battery cell.

In an embodiment, step S220 may include a step of forming one or more holes in a part of the protruding portion. In such a case, step S220 may further include a step of connecting a wire by allowing the wire to pass through the one or more holes, winding the wire, and soldering the wire.

In another embodiment, step S220 may include a step of forming one or more grooves in a part of the protruding portion. In such a case, step S220 may further include a step of connecting the wire by seating the wire in the one or more grooves and soldering the wire.

The method for manufacturing an electrode tab according to an embodiment of the present disclosure described above has been described with reference to the flow chart presented in the drawings. For simplicity, the method has been illustrated and described as a series of blocks, but the present disclosure is not limited to the order of the blocks, and some blocks may occur in a different order or simultaneously with other blocks illustrated and described in the present specification, and various other branches, flow paths, and orders of blocks that achieve the same or similar results may be implemented. In addition, all the illustrated blocks may not be required for implementing the method described in the present specification.

In the description with reference to FIG. 9, each step may be further divided into additional steps or combined into fewer steps, depending on the implementation example of the present disclosure. In addition, some steps may be omitted as needed, and the order between the steps may be changed.

In addition, even in the case of other omitted content, the content of FIGS. 1A, 1B, 2A, 2B, 2C, 3, 4A, 4B, 4C, 5A, 5B, 6A, 6B, 7A, 7B, and 8 may be applied to the content of FIG. 9. In addition, the content of FIG. 9 may be applied to the content of FIGS. 1A, 1B, 2A, 2B, 2C, 3, 4A, 4B, 4C, 5A, 5B, 6A, 6B, 7A, 7B, and 8.

Hereinafter, materials which may be used in a secondary battery according to an embodiment of the present disclosure are described.

A compound (e.g., a lithiated intercalation compound) capable of reversible intercalation and deintercalation of lithium may be used as a positive electrode active material.

Specifically, one type or more selected among complex oxides of metal, selected among cobalt, manganese, nickel, and a combination of them, and lithium may be used as the positive electrode active material.

The complex oxide may be lithium transition metal complex oxide. A detailed example of the complex oxide may include lithium nickel-based oxide, lithium cobalt-based oxide, lithium manganese-based oxide, a lithium ferrous phosphate-based compound, cobalt-free nickel-manganese-based oxide, or a combination thereof.

For example, a compound that is represented as one of the following chemical formulas may be used: LiₐA_{1-b}X_{b}O_{2-c}D_{c} (0.90≤a≤1.8, 0≤b≤0.5, 0≤c'0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2) ; LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1) ; LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂ (PO₄)₃ (0≤f≤2) ; and LiₐFePO₄ (0.90≤a≤1.8).

In the chemical formula, A may be Ni, Co, Mn, or a combination thereof. X may be Al, Ni, Co, Mn, Cr, Fe, Mg, Sr, V, a rare earth element, or a combination thereof; D may be O, F, S, P, or a combination thereof. G may be Al, Cr, Mn, Fe, Mg, La, Ce, Sr, V, or a combination thereof. L¹ may be Mn, Al, or a combination thereof.

A positive electrode for a lithium secondary battery may include a current collector and a positive electrode active material layer formed on the current collector. The positive electrode active material layer may include the positive electrode active material, and may further include a binder and/or a conductive material.

Content of the positive electrode active material may be 90 wt. % to 99.5 wt. % with respect to the positive electrode active material layer 100 wt. %. Content of the binder and the conductive material may be 0.5 wt. % to 5 wt. % with respect to the positive electrode active material layer 100 wt. %.

Al may be used as the current collector, but the present disclosure may not be limited thereto.

A negative electrode active material may include a material capable of reversible intercalation/de-intercalation with respect to lithium ions, lithium metal, an alloy of lithium metal, a material capable of doping and dedoping with respect to lithium, or transition metal oxide.

The material capable of reversible intercalation/de-intercalation with respect to lithium ions may include a carbon-based negative electrode active material, for example, crystalline carbon, amorphous carbon, or a combination thereof. An example of the crystalline carbon may include graphite, such as natural graphite or synthetic graphite. Examples of the amorphous carbon may include soft or hard carbon, mesophase pitch carbide, and fired coke.

An Si-based negative electrode active material or an Sn-based negative electrode active material may be used as the material capable of doping and dedoping with respect to lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According £ to an example implementation, the silicon-carbon composite may include silicon particles, and may have a form in which amorphous carbon has been coated on surfaces of silicon particles.

The silicon-carbon composite may further include crystalline carbon. For example, the silicon-carbon composite may include a core including crystalline carbon and silicon particles, and an amorphous carbon coating layer disposed on a surface of the core.

A negative electrode for a lithium secondary battery may include a current collector and a negative electrode active material layer disposed on the current collector. The negative electrode active material layer may include the negative electrode active material, and may further include a binder and/or a conductive material.

For example the negative electrode active material layer may include the negative electrode active material of 90 wt. % to 99 wt. %, the binder of 0.5 wt. % to 5 wt. %, and the conductive material of 0 wt. % to 5 wt. %.

A nonaqueous-based binder, an aqueous-based binder, a dry binder, or a combination thereof may be used as the binder. If the aqueous-based binder is used as a binder for the negative electrode, the binder for the negative electrode may further include a cellulose-series compound capable of assigning viscosity.

A material selected among nickel foil, stainless steel foil, titanium foil, nickel foam, copper foam, a polymer base on which a conductive metal has been coated, and a combination thereof may be used as a current collector for the negative electrode.

An electrolyte for a lithium secondary battery may include a nonaqueous organic solvent and lithium salts.

The nonaqueous organic solvent may play a role as a medium through which ions that are involved in an electrochemical reaction of a battery can move.

The nonaqueous organic solvent may be a carbonate-based, ester-based, ether-based, ketone-based, or alcohol-based solvent, an aprotic solvent, or a combination thereof. The carbonate-based, ester-based, ether-based, ketone-based, or alcohol-based solvent, or the aprotic solvent may be used solely, or two types or more of them may be mixed and used as the nonaqueous organic solvent.

Furthermore, if the carbonate-based solvent is used, annular carbonate and chain carbonate may be mixed and used.

A separator may be present between the positive electrode and the negative electrode depending on the type of lithium secondary battery. Polyethylene, polypropylene, and polyvinylidene fluoride, or a multi-layer having two or more layers thereof may be used as the separator.

The separator may include a porous base, and a coating layer including an organic matter, an inorganic matter, or a combination thereof that is disposed on one or both sides of the porous base.

The organic matter may include a polyvinylidene fluoride-based heavy antibody or (meth)acrylic polymer.

The inorganic matter may include inorganic particles selected among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but the present disclosure is not limited thereto.

The organic matter and the inorganic matter may have a form in which the organic matter and the inorganic matter have been mixed in one coating layer or a form in which a coating layer including the organic matter and a coating layer including the inorganic matter have been stacked.

Although the present disclosure has been described above in connection with the limited embodiments and drawings, the present disclosure is not limited to the embodiments. A person having ordinary knowledge in the art to which the present disclosure pertains may modify and change the present disclosure within the technical spirit of the present disclosure and the equivalent range of the following claims.

What is claimed is:

1. An electrode tab electrically connected to a terminal of a battery cell, comprising:
a bonding portion formed to have an area corresponding to an area of the terminal of the battery cell and bonded to the terminal of the battery cell;
a protruding portion formed to protrude from the bonding portion; and
a wire connection portion formed in the protruding portion and for connecting, to the electrode tab, a wire that is electrically connected to the battery cell.

2. The electrode tab as claimed in claim 1, wherein the wire connection portion comprises one or more holes formed in a part of the protruding portion.

3. The electrode tab as claimed in claim 2, wherein the wire connection portion connects the wire by allowing the wire to pass through the one or more holes, such that the wire can be wound and soldered.

4. The electrode tab as claimed in claim 1, wherein the wire connection portion comprises one or more grooves formed in a part of the protruding portion.

5. The electrode tab as claimed in claim 4, wherein the wire connection portion connects the wire by seating the wire in the one or more grooves such that the wire can be soldered.

6. The electrode tab as claimed in claim 1, wherein the bonding portion is bonded to the terminal of the battery cell through laser welding or resistance welding.

7. The electrode tab as claimed in claim 1, wherein the electrode tab is formed through a hemming process or a casting process.

8. A battery pack comprising:
a plurality of battery cells;
a plurality of electrode tabs each being electrically connected to a respective terminal of a respective one of the plurality of battery cells; and
a plurality of wires that electrically connect the plurality of electrode tabs,
wherein each electrode tab of the plurality of electrode tabs comprises:
a bonding portion formed to have an area corresponding to an area of the terminal of the battery cell and bonded to the terminal of the battery cell;
a protruding portion formed to protrude from the bonding portion; and
a wire connection portion formed in the protruding portion and for connecting the wire to the electrode tab.

9. The battery pack as claimed in claim 8, wherein the wire connection portion comprises one or more holes formed in a part of the protruding portion.

10. The battery pack as claimed in claim 9, wherein the wire connection portion connects the wire by allowing the wire to pass through the one or more holes, such that the wire can be wound.

11. The battery pack as claimed in claim 8, wherein the wire connection portion comprises one or more grooves formed in a part of the protruding portion.

12. The battery pack as claimed in claim 11, wherein the wire connection portion connects the wire by seating the wire in the one or more grooves, such that the wire can be soldered.

13. The battery pack as claimed in claim 8, wherein the bonding portion is bonded to the terminal of the battery cell through laser welding or resistance welding.

14. The battery pack as claimed in claim 8, wherein the electrode tab is formed through a hemming process or a casting process.

15. A method for manufacturing an electrode tab electrically connected to a terminal of a battery cell, comprising:
forming a bonding portion such that the bonding portion has an area corresponding to an area of the terminal of the battery cell and the electrode tab is configured for bonding to the terminal of the battery cell, and a protruding portion that protrudes from the bonding portion; and
forming, in the protruding portion, a wire connection portion for connecting a wire electrically connected to the battery cell.

16. The method for manufacturing an electrode tab as claimed in claim 15, wherein the forming of the wire connection portion comprises:
forming one or more holes in a part of the protruding portion.

17. The method for manufacturing an electrode tab as claimed in claim 16, wherein the forming of the wire connection portion further comprises:
connecting the wire by passing the wire through the one or more holes, winding the wire, and soldering the wire.

18. The method for manufacturing an electrode tab as claimed in claim 15, wherein the forming of the wire connection portion comprises:
forming one or more grooves in a part of the protruding portion.

19. The method for manufacturing an electrode tab as claimed in claim 18, wherein the forming of the wire connection portion further comprises:
connecting the wire by seating the wire in the one or more grooves and soldering the wire.

20. The method for manufacturing an electrode tab as claimed in claim 15, wherein the forming of the bonding portion and the protruding portion that protrudes from the bonding portion comprises:
forming the bonding portion and the protruding portion through a hemming process or a casting process.
